(19) United States
(12) Patent Application Publication
(10) Pub. No.: US 2026/0074651 A1
(43) Pub. Date: Mar. 12, 2026

(54) FILM COVERED SOLAR PANEL

(71) Applicant: SAUDI ARABIAN OIL COMPANY, Dhahran (SA)

(72) Inventors: Maha NOUR, Dhahran (SA); Marwan ABDULLAH, Dhahran (SA); Brian PARROTT, Dhahran (SA); Anas BINTIN, Dhahran (SA); Sarah AQEEL, Dhahran (SA)

(73) Assignee: SAUDI ARABIAN OIL COMPANY, Dhahran (SA)

(21) Appl. No.: 18/883,903

(22) Filed: Sep. 12, 2024

(51) Int. Cl. H02S 40/10

(52) U.S. Cl. CPC H02S 40/10

(57) ABSTRACT

A system is disclosed including a solar panel, a drive shaft operatively coupled to the solar panel, a sensor to sense a power output from the solar panel, and a controller programmed to receive the power output, conduct a first comparison between the power output and a power output threshold, rotate the drive shaft based on the first comparison, conduct a second comparison between the power output and the power output threshold, and cease rotation of the drive shaft based on the second comparison. Rotating the drive shaft feeds an amount of film from a source roll of film over a face of the solar panel and feeds an amount of film from a cover portion of film extending from the source roll of film around the drive shaft.

### FIELD OF THE DISCLOSURE

The present disclosure relates generally to solar panels and, more particularly, to systems and methods of using disposable rolls of film to cover solar panels in remote areas.

### BACKGROUND OF THE DISCLOSURE

Oil and natural gas rigs and platforms (collectively “platforms”) are used to extract hydrocarbons from subterranean reservoirs. While some of these platforms are easy to power via cables connected to traditional grid power sources, the costs to deploy power cables to remote locations, such as floating platforms positioned in the sea, can be very high. Accordingly, in some instances, these power platforms utilize solar panels as an alternative to grid power.

These oil and natural gas platforms require power during both day and night, such as to communicate (e.g. radio) as well as to power to control systems (e.g. SCADA systems). As such, when the platforms are powered by renewable, non-continuous power sources, such as solar panels, they are often also provided with battery systems to provide continuous power.

Due to the environment in which they are located, many of these solar panels require cleaning on a somewhat frequent basis to address the buildup of foreign contaminants, such as dust deposition, salt buildup, bird/animal waste, and/or growth of organisms. When a solar panel fails to generate sufficient power over a prolonged period of time, such as due to the aforementioned buildup of foreign contaminants and/or shade, the power to the platform is maintained by the battery system. This may cause the battery system to over-discharge in order to keep the platform running, causing the battery system to suffer irreversible damage that results in significant costs of replacement as well as ongoing downtime for the systems after sunset until the battery systems are replaced.

The cost of manually cleaning the solar panels and replacing damaged batteries due to the inability to provide cleaning before full discharge is tremendous from both cost and environmental perspectives. Accordingly, systems and methods for keeping a solar panel clean are desirable.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system may include a solar panel, a drive shaft operatively coupled to the solar panel, a sensor to sense a power output from the solar panel, and a controller programmed to receive the power output from the sensor, conduct a first comparison between the power output and a power output threshold, rotate the drive shaft based on the first comparison, conduct a second comparison between the power output and the power output threshold, and cease rotation of the drive shaft based on the second comparison. Rotating the drive shaft feeds an amount of film from a source roll of film over a face of the solar panel and feeds an amount of film from a cover portion of film extending from the source roll of film around the drive shaft.

According to another embodiment consistent with the present disclosure, a method includes receiving a power output from a solar panel having a drive shaft operatively coupled thereto, conducting a first comparison between the power output and a power output threshold, rotating drive shaft based on the first comparison and thereby feeding an amount of film from a source roll of film over a face of the solar panel and feeding an amount of the film from a cover portion of film extending from the source roll of film around the drive shaft, conducting a second comparison between the power output and the power output threshold, and ceasing rotation of the drive shaft based on the second comparison.

According to another embodiment consistent with the present disclosure, a system includes a plurality of solar panel assemblies, a sensor to sense a power output from each solar panel assembly, and a controller. Each solar panel assembly comprises a solar panel comprising a face and including a drive shaft operatively coupled to the solar panel. Rotating the drive shaft feeds an amount of film from a source roll of film over the face of the solar panel and feeds an amount of film from a cover portion of film extending from the source roll of film around the drive shaft. The controller is programmed to receive, from the sensor, the power output, conduct a first comparison between the power output and a power output threshold, and selectively rotate the drive shafts of a subset of the plurality of solar panel assemblies based on the first comparison.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an isometric view of an example solar panel that may incorporate the principles of the present disclosure.

FIG. 2 is a schematic side view of a solar panel assembly that includes the solar panel of FIG. 1, film for protecting a face of the solar panel, and first and second drive shafts for refreshing the film over time, and that is communicably coupled to a controller, according to at least one aspect of the present disclosure.

FIG. 3 is the solar panel assembly of FIG. 2 after a partial refresh of the film, according to at least one aspect of the present disclosure.

FIG. 4 is the solar panel assembly of FIG. 2 after a complete refresh of the film, according to at least one aspect of the present disclosure.

FIG. 5 is the solar panel assembly of FIG. 2 further including protective covers at least partially surrounding a source roll of the film and the first and second drive shafts, according to at least one aspect of the present disclosure.

FIG. 6 is the solar panel assembly of FIG. 2 further including a filter, according to at least one aspect of the present disclosure.

FIG. 7 is the solar panel assembly of FIG. 6 with the filter pushing contaminant off the film prior to being wrapped around the second drive shaft, according to at least one aspect of the present disclosure.

FIG. 8 is the solar panel assembly of FIG. 2 further including arms for guiding the film along the face of the solar panel, according to at least one aspect of the present disclosure.

FIG. 9 is a cross-sectional view of the solar panel assembly of FIG. 8, according to at least one aspect of the present disclosure.

FIG. 10 is the solar panel assembly of FIG. 2 further including clips in a released state, according to at least one aspect of the present disclosure.

FIG. 11 is the solar panel assembly of FIG. 10 with the clips transitioned to a grasping state, according to at least one aspect of the present disclosure.

FIG. 12 is a schematic view of a system including a plurality of solar panel assemblies of FIG. 2 coupled to the controller of FIG. 2, according to at least one aspect of the present disclosure.

FIG. 13 is a method, according to at least one aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to solar panels and, more particularly, to systems and methods of using disposable rolls of film to cover solar panels in remote areas. More specifically, the present disclosure provides film that may extend over a face of a solar panel to protect the solar panel from foreign contamination. The system further includes a controller that monitors one or more parameters associated with the solar panel. Based on these parameters, the controller rotates first and second drive shafts to feed film from a source roll of film operably coupled to the first drive shaft over the face of the solar panel, and feed an amount of film from a cover portion of film extending from the source roll and over the face of the solar panel around the second drive shaft. The system therefore provides the ability automatically replace the film that covers the solar panel, thereby extending the amount of time that the solar panel can effectively generate energy without user intervention.

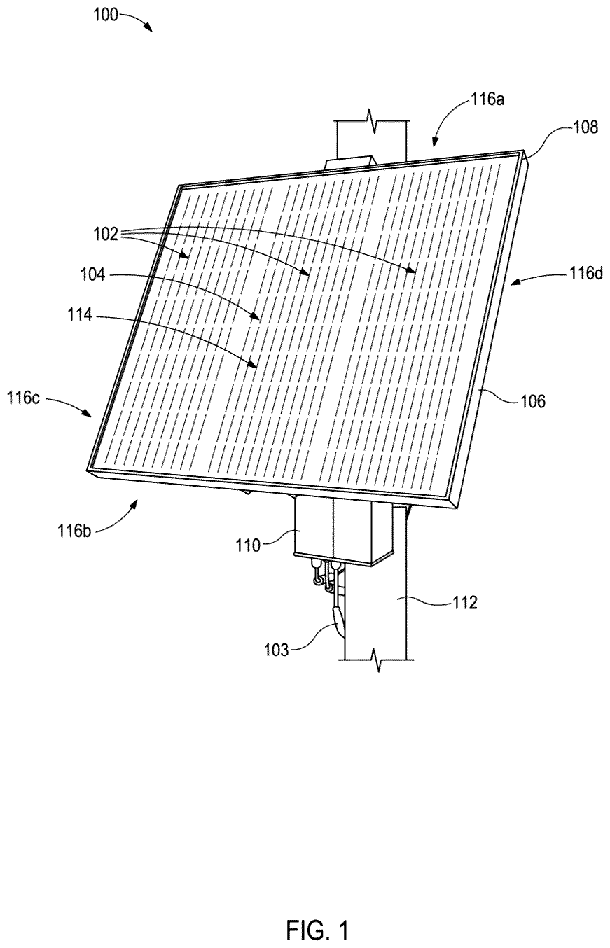

FIG. 1 is an isometric view of an example solar panel 100 that may incorporate the principles of the present disclosure. The solar panel 100 functions to convert sunlight into electrical energy through a process known as the photovoltaic (PV) effect. The solar panel 100 includes a plurality of PV cells 102, which may be made from semiconductor materials like silicon, for example. When sunlight strikes the PV cells 102, it excites electrons in the semiconductor material, causing them to break free from their atoms.

The free electrons are collected by a conductive grid made of materials like silver or aluminum, for example, which is applied to the surface of the cells 102. These electrons then flow through wires that connect the individual cells 102 in series or parallel configurations, forming a circuit and generating direct current (DC) electricity. This DC electricity may then be converted to alternating current (AC) using an inverter, making it suitable for use in applications like powering an oil and natural gas platform.

The PV cells 102 may be encapsulated between a transparent front layer 104, which may be made of tempered glass, and a back layer 106, which may be made of a polymer, to protect against environmental factors and mechanical stress. The solar panel 100 may further include a frame 108 to enclose the PV cells 102, the front layer 104, and the back layer 106. The frame 108 may provide structural support and facilitate mounting and installation of the solar panel 100. The frame 108 may include a transparent front layer 114 (i.e., the “face” of the solar panel 100), which may be made of tempered glass, for example, and may be aligned with the transparent front layer 104 such that sunlight may reach the PV cells 102 via the transparent front layers 104, 114.

The solar panel 100 may further include first, second, third, and fourth sides 116a-d and a junction box 110 that may be mounted to the frame 108 adjacent the second side 114b. The junction box 110 may house electrical connections and diodes that prevent backflow of current. In some applications, the solar panel 100 and the junction box 110 may be mounted to a support 112, such as a pole, for example, to elevate the solar panel 100 above the ground so that it can be oriented toward the sun.

Due to the environment in which it may be located, the solar panel 100 may require cleaning on a somewhat frequent basis to address the accumulation of foreign contamination on the face 114 of the solar panel 100. Examples of foreign contamination include, but are not limited to, dust deposition, salt buildup, bird/animal waste, ecological growth, organism growth, and any combination thereof. According to embodiments of the present disclosure, the solar panel 100 may further include a disposable roll of transparent film operable to keep the solar panel 100 clean in remote locations while simultaneously allowing the sunlight through. When a sufficient level of contamination builds up on the film, the system may be actuated to roll up the used portion of the film while simultaneously rolling out a new section to provide a transparent, new, and clean surface on the solar panel 100.

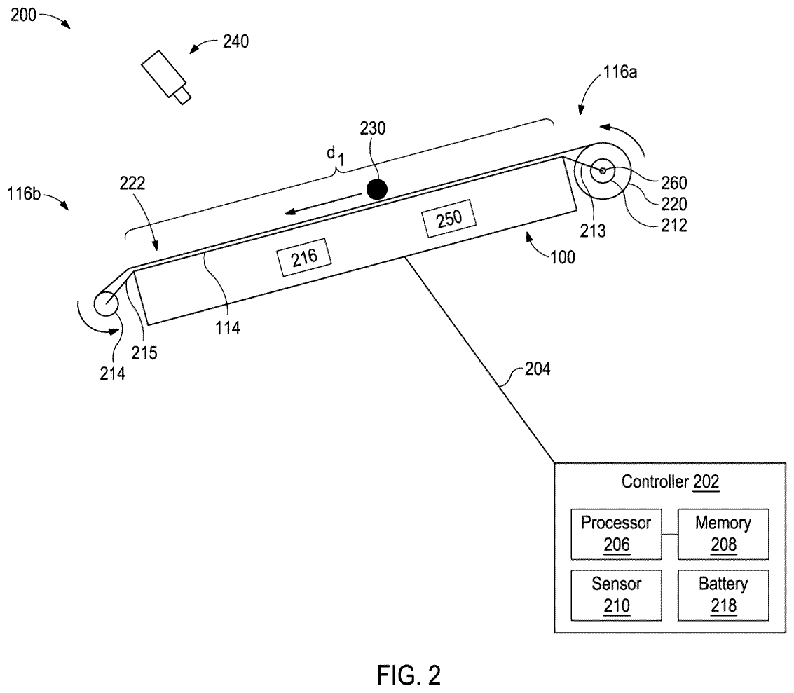

FIG. 2 is a schematic side view of a solar panel assembly 200, according to at least one aspect of the present disclosure. The solar panel assembly 200 may include the solar panel 100 which, as discussed above, may be operable to generate electricity (e.g. AC electricity). This electricity may be transmitted from the solar panel 100 to a controller 202 via a wire 204 and the controller 202 may selectively distribute the electricity, such as to an oil and natural gas platform.

The controller 202 may include a processor 206 and a memory 208 storing computer readable instructions executable by the processor 206. Examples of the memory 208 include, but are not limited to, random access memory (RAM), read-only memory (ROM), computer chips, optical discs (e.g., compact discs (CDs), digital video discs (DVDs), etc.), magnetic disks (e.g., hard disk drives (HDDs), floppy disks, ZIP® disks, etc.), magnetic tape, and solid state storage devices (e.g., memory cards, “flash” media, etc.). As used herein, the term “computer readable medium” refers to any device or system for storing and providing information (e.g., data and instructions) to the processor 206. Examples of computer readable media include, but are not limited to, optical discs, magnetic disks, magnetic tape, solid-state media, and servers for streaming media over networks. Based on instructions stored in the memory 208, the processor 206 may be configured to perform various operations, as will be described in more detail elsewhere herein.

The controller 202 may further include a sensor 210, such as a current sensor or a voltage sensor, for example, for measuring an amount of power generated by the solar panel 100 and a battery 218 for powering various components of the solar panel assembly 200. The battery 218 may be a rechargeable battery and may be recharged by power generated by the solar panel 100.

The solar panel assembly 200 may further include a first drive shaft 212 operably coupled to the first side 116a of the solar panel 100 with a first connector 213, and a second drive shaft 214 operably coupled to the second side 116b of the solar panel 100 with a second connector 215. The first and second connectors 213, 215 may be coupled to the first and second sides 116a, b of the solar panel 100 using one or more fasteners (e.g. screws, bolts, nails, anchors, rivets, etc.). The first and second connectors 213, 215 can enable the first and second drive shafts 212, 214 to be retrofit to existing solar panels.

The solar panel assembly 200 may further include a motorized system 216 operable (actuatable) to rotate the first and second drive shafts 212, 214 relative to the solar panel 100. As used herein, the phrase “rotating the first and second drive shafts 212, 214” may refer to a) actively rotating both the first and second drive shafts 212, 214 with the motorized system 216, or b) actively rotating only one of the drive shafts 212, 214 with the motorized system 216, and thereby causing the other drive shaft 212, 214 to passively rotate by way of the film extending therebetween. The motorized system 216 may include at least one actuator (e.g., chains, cables, servos, a pneumatic actuator, a mechanical actuator, an electromechanical actuator, etc.) operably coupled to at least one of the first and second drive shafts 212, 214, and at least one motor to drive the at least one actuator, thereby rotating the first and second drive shafts 212, 214, as described above. The controller 202 may be in operable communication with the motorized system 216 such that the controller 202 can energize (operate) the motorized system 216, such as with the battery 218, to drive (rotate) the first and second drive shafts 212, 214.

The solar panel assembly 200 may further include a source roll of film 220 disposed around and operably coupled to the first drive shaft 212, and a cover portion of film 222 extending from the source roll of film 220, over a distance di of the face 114, and to the second drive shaft 214. As one example, the distance d₁ of the face 114 can be about 1 meter, and the source roll of film 220 may include 55 meters of the film. The film may comprise a transparent material made of plastic, a thermoplastic polymer, such as polylactic acid (PLA), or an amorphous polymer, such as Cyclic olefin copolymer (COC), as examples. The film may permit sunlight to shine (penetrate) therethrough, such that the sunlight can be received by the PV cells 102 (FIG. 1) through the film, the face 114 and the transparent layer 104 (FIG. 1).

Referring to FIGS. 2-4, an example operation of the system 200 is shown. As illustrated, the cover portion of the film 222 may extend over the face 114 of the solar panel 100 to block foreign contaminants 230 (e.g. dust deposition, salt buildup, bird/animal waste, and/or growth of organisms) from reaching the face 114 of the solar panel 100. When desired, the controller 202 may energize the motorized system 216 to rotate the first and second drive shafts 212, 214, thereby causing the cover portion of the film 222 with the contaminants 230 adhered thereto (i.e., “dirty” cover portion of film 222) to progressively wrap around the second drive shaft 214 while film from the source roll of film 220 (i.e., “new” cover portion of film 300) is extended (advanced) over the face 114, thereby permitting more light to reach the PV cells 102 (FIG. 1).

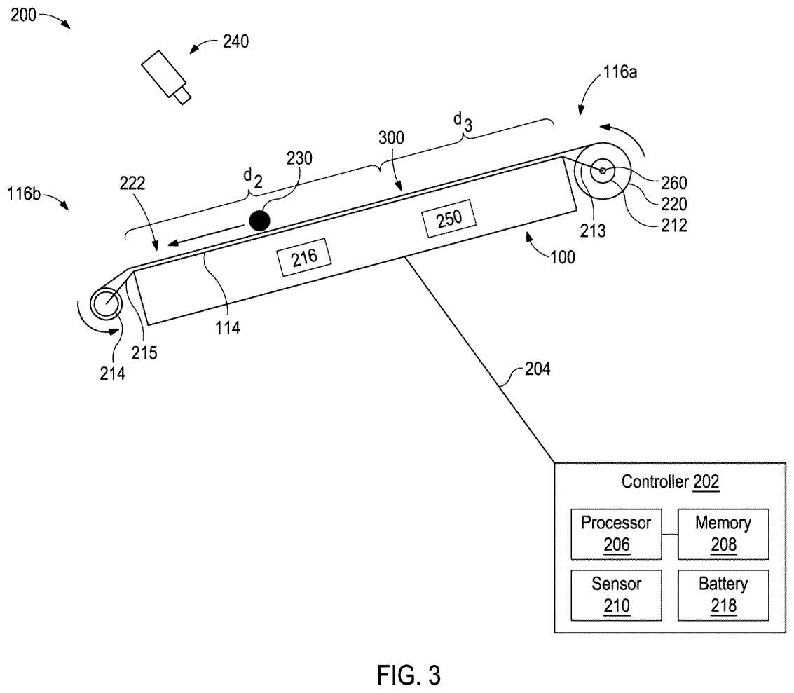

Referring to FIG. 3, in some embodiments, the controller 202 may rotate the first and second drive shafts 212, 214 such that a portion of the dirty cover portion of film 222 remains over the face 114 and covers a distance d₂, while a new cover portion of film 300 from the cover source roll of film 220 extends over the face 114 and covers a distance d₃. This may be referred to as a “partial refresh,”where d₂+d₃=d₁ (FIG. 2).

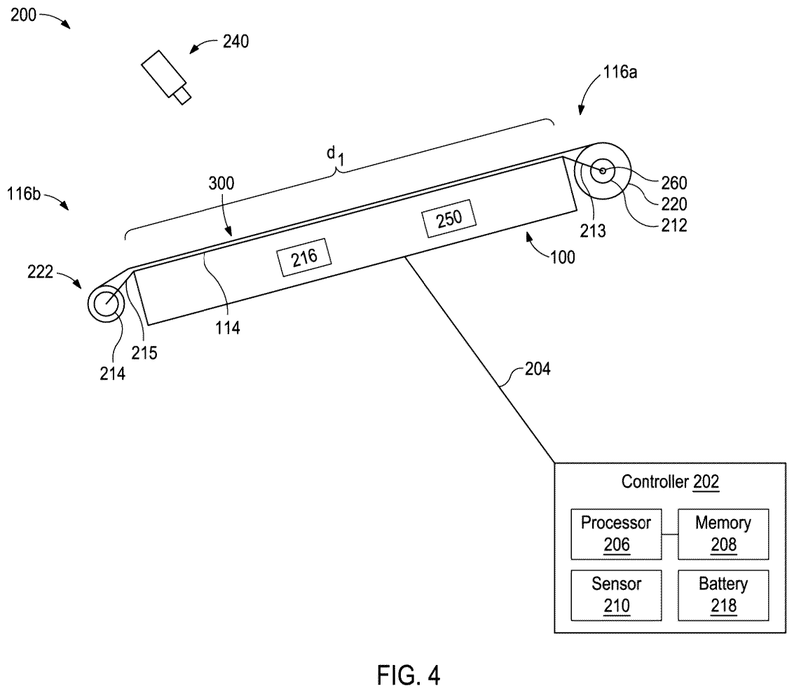

Referring to FIG. 4, in some embodiments, the controller 202 may rotate the first and second drive shafts 212, 214 such that substantially all the dirty cover portion of film 222 is wrapped around the second drive shaft 214 while a new cover portion of film 300 from the source roll of film 220 (d₁) extends over the face 114. This may be referred to as a “complete refresh”.

The controller 202 may be in operable communication with one or more data sources that function to sense a condition of the cover portion of film 222 over time. The controller 202 may receive data from the one or more data sources and determine when and how much to rotate the first and second drive shafts 212, 214 based on the received data, alone or in combination with each other.

For instance, the controller 202 may determine an amount of power generated by the solar panel 100 via the sensor 210 and compare the generated power to a power output threshold, which may be stored in the memory 208. In some instances, the controller 202 may compare the generated power to the power output threshold at one or more times of the day when a sufficient amount of light is expected to be received (e.g., a peak hour, like noon). Based on the generated power approaching, reaching, or dropping below the power output threshold, the controller 202 may energize the motorized system 216 to rotate the first and second drive shafts 212, 214, thereby feeding (wrapping) film from the dirty cover portion of film 222 around the second drive shaft 214 while feeding (extending) new film 300 from the source roll of film 220 over the face 114 to permit more light to reach the PV cells 102 (FIG. 1).

As the controller 202 rotates the first and second drive shafts 212, 214, as described above, the controller 202 may monitor the generated power by the solar panel 100 with the sensor 210 and compare the generated power to the power output threshold. Based on the generated power approaching, reaching, or exceeding the power output threshold, the controller 202 may cease providing power to the motorized system 216, thereby stopping the first and second drive shafts 212, 214 from rotating. In some instances, the solar panel 100 may require a complete refresh of film (see e.g., FIG. 4) to bring the generated power back to the power level threshold. However, in some instances, the solar panel 100 may only require a partial refresh of film (see e.g., FIG. 3) to bring the generated power back to the power level threshold. Accordingly, by comparing the generated power to the power level threshold, the controller 202 may not require a complete refresh of film. Using less film than is necessary to maintain proper power output is beneficial from an environmental perspective (less waste) and increases the amount of time until it is needed to replace the source roll of film 220.

In some embodiments, the solar panel assembly 200 may further include a camera 240 to visualize the cover portion of film 222. The controller 202 may be in operable communication with the camera 240 (either wired or wirelessly) and may receive visualization data from the camera 240. For instance, the camera 240 may be operable to image the amount (quantity) of contaminants 230 on the cover portion of the film 222 and/or an amount of the cover portion of film 222 that is covered in contaminants 230 (degree of coverage). The controller 202 may receive this visualization data, ascertain an amount of contaminant on the cover portion of film 222, and compare the amount of visualized contaminant to a visualized contaminant threshold, which may be stored in the memory 208. Based on the visualized amount of contaminant approaching, reaching, or exceeding visualized contaminant threshold, the controller 202 may energize the motorized system 216 to rotate the first and second drive shafts 212, 214, thereby feeding (wrapping) film from the dirty cover portion of film 222 around the second drive shaft 214 while feeding (extending) new film 300 from the source roll of film 220 over the face 114.

As the controller 202 rotates the first and second drive shafts 212, 214, as described above, the controller 202 may monitor the remaining amount of visualized contaminant over the face 114 of the solar panel 100 and compare the remaining amount of visualized contaminant to the visualized contaminant threshold. Based on the remaining amount of visualized contaminant approaching, reaching, or dropping below the visualized contaminant threshold, the controller 202 may cease providing power to the motorized system 216, thereby stopping the first and second drive shafts 212, 214 from rotating. In some instances, the solar panel 100 may require a complete refresh of film (see e.g., FIG. 4) to drop below the visualized contaminant threshold. However, in some instances, the solar panel 100 may only require a partial refresh of film (see e.g., FIG. 3) to bring the visualized contaminant below the visualized contaminant threshold. Accordingly, by comparing the visualized contaminant to the visualized contaminant threshold, the controller 202 may not require a complete refresh of film. Using less film than needed is beneficial from an environmental perspective (less waste) and increases the amount of time to replace the source roll of film 220.

In some embodiments, the solar panel 100 may further include a plurality of current sensors 250 (only one shown) operable to sense a current across a subset (one or more) of the PV cells 102 (FIG. 1). The controller 202 may be in operable communication with the current sensors 250 and may receive a current output from each current sensor 250. The current output may be indicative of an amount of light being received by a corresponding subset of PV cells 102, which may be indicative of a relative transparency of the cover portion of film 222 over the corresponding subset of PV cells 102. The controller 202 may determine that the current output received from a current sensor 250 is less than a current threshold, which may be stored in the memory 208. Accordingly, the controller 202 may determine that the subset of PV cells 102 associated with corresponding current sensor 250 is not receiving a sufficient amount of light, possibly due to the section of cover portion of film 222 over the subset of PV cells 102 being too dirty.

Based on a threshold number of current sensors 250 outputting currents less than the current threshold, the controller 202 may energize the motorized system 216 to rotate the first and second drive shafts 212, 214, thereby feeding (wrapping) film from the dirty cover portion of film 222 around the second drive shaft 214 while feeding (extending) new film 300 from the source roll of film 220 over the face 114. The threshold number of current sensors 250 may be stored in the memory 208.

As the controller 202 rotates the first and second drive shafts 212, 214, as described above, the controller 202 may compare the currents from the current sensors 250 to the current threshold. Based on the threshold number of current sensors 250 outputting currents above the current threshold being reached, the controller 202 may cease providing power to the motorized system 216, thereby stopping the first and second drive shafts 212, 214 from rotating. In some instances, the solar panel 100 may require a complete refresh of film (see e.g., FIG. 4) to bring the threshold number of current sensors 250 above the current sensor threshold. However, in some instances, the solar panel 100 may only require a partial refresh of film (see e.g., FIG. 3) to bring the threshold number of current sensors 250 above the current sensor threshold. Accordingly, by monitoring currents of subsets of the PV cells 102, the controller 202 may not require a complete refresh of film. Using less film than needed is beneficial from an environmental perspective (less waste) and increases the amount of time to replace the source roll of film 220.

The controller 202 may further determine when and for how long to rotate the first and second drive shafts 212, 214 based on a model of anticipated cleaning requirements and how much material of the source roll of film 220 would be used prior to a new roll of film 220 being available. For instance, the solar panel assembly 200 may further include a sensor 260, such as an encoder, for example, operably coupled to the first drive shaft 212 for measuring rotation thereof. The sensor 260 may be in operable communication with the controller 202 such that the controller 202, using rotation data from the sensor 260, can track the amount of film used from the source roll of film 220 over time. A user may provide the controller 202 with the amount (length) of film on the source roll of film 220 and the controller 202 can track the amount (length) of film remaining on the source roll of film 220 over time using data from the sensor 260. The controller 202 may perform a function based on the amount of film remaining on the source roll of film 220 dropped below a threshold amount of film remaining, which may be stored in the memory 208. The function may be generating an alert (audible or visual, example) and/or adjusting one or more thresholds, as will be described in more detail below.

Using the one or more data sources (sensor 210, camera 240, sensor 250, etc.), the controller 202 may determine that the first and second drive shafts 212, 214 should be rotated. However, as discussed above, the controller 202 may know that only a fraction of the source roll of film 220 remains and that a new source roll of film may not be available for a period of time. Accordingly, the controller 202 may function to adjust when and for how long to rotate the first and second drive shafts 212, 214 further based on the amount of film remaining on the source roll of film 220, such as by adjusting one or more thresholds stored in the memory 208. For example, the controller 202 may decrease the power level threshold associated with the sensor 210, increase the visualized contaminant threshold associated with the camera 240, and/or current sensor threshold associated with the sensors 250 based on the amount of film remaining on the source roll of film 220 dropping below the threshold amount of film remaining. The controller 202 may further utilize historical data, which may be stored in the memory 208, to improve the predicted model of anticipated cleaning requirements.

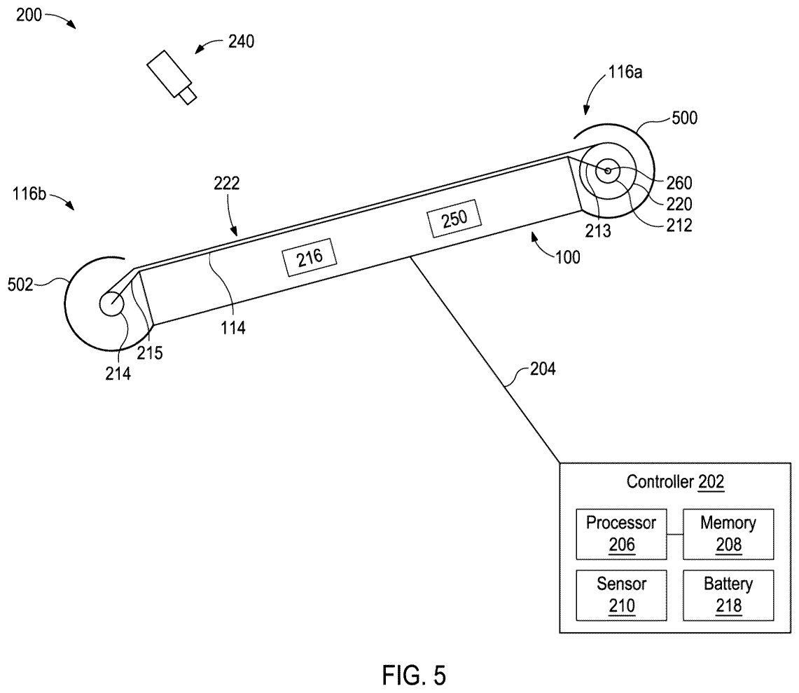

Referring now to FIG. 5, the solar panel assembly 200 may further include a first protective cover 500 and a second protective cover 502. The first protective cover 500 may extend from the first side 116a of the solar panel 100 and may at least partially surround the source roll of film 220 and the first drive shaft 212. In contrast, the second protective cover 502 may extend from the second side 116b of the solar panel 100 and may at least partially surround the second drive shaft 214 and any accumulated dirty film wound therearound. The protective covers 500, 502 may provide shading and protection to the film to prevent the film from being damaged (wind damage or UV degradation, for example), which could lead to breakage of the film. The protective covers 500, 502 may also prevent the film from accumulating contaminant (e.g. dust deposition, salt buildup, bird/animal waste, and/or growth of organisms) when not being used to cover the face 114 of the solar panel 100.

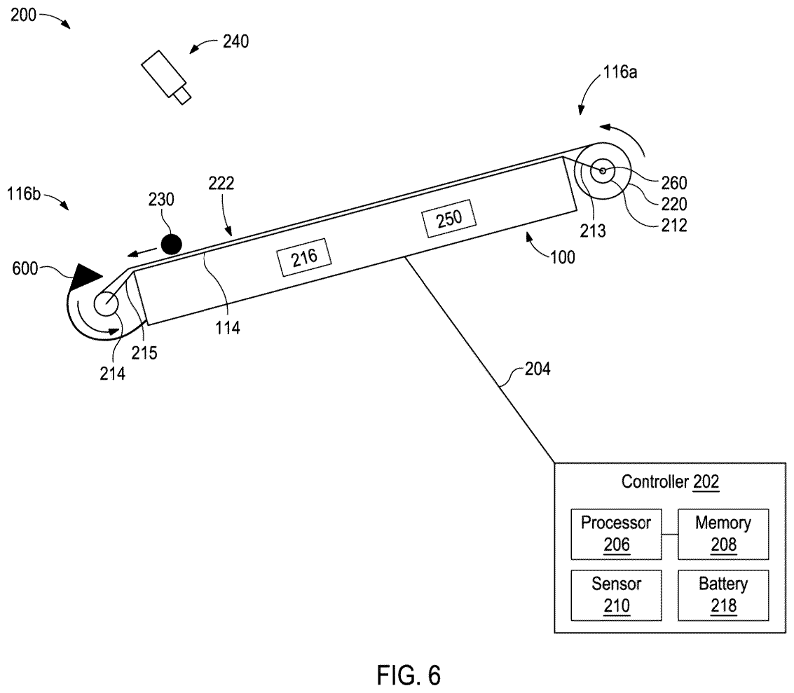

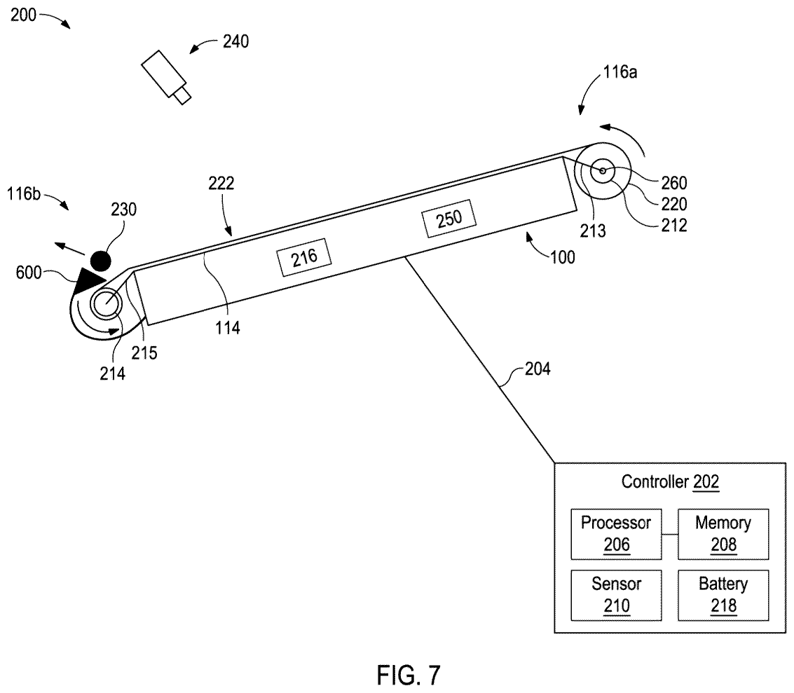

Referring now to FIGS. 6 and 7, the solar panel assembly 200 may further include a contaminant removal device or “contaminant remover” 600 operable to remove contaminant greater than a threshold contaminant size as the dirty cover portion of the film 222 is being wrapped around the second drive shaft 214. The contaminant removal device 600 may comprise a variety of tools, components, or structural members capable of removing contaminants from the film as it is received at the second drive shaft 214. Examples of the contaminant removal device 600 include, but are not limited to, a ramp, a wedge, a scraper, a brush, or any combination thereof.

Referring to FIG. 6, as the contaminant 230 (which is greater than the threshold contaminant size) approaches the contaminant removal device 600, the contaminant 230 abuts a portion of the contaminant removal device 600, thereby causing the contaminant to be dislodged or separated from (e.g., pushed off) the dirty cover portion of film 222 (FIG. 7) prior to the dirty cover portion of film 222 being wrapped around the second drive shaft 214. Removing larger contaminant from the dirty cover portion of film 222 before rolling reduces the needed space for the used film. This may be partially beneficial, for example, when the contaminant removal device 600 is combined with a protective cover 502 (FIG. 5) as the second cover 502 may define a boundary at which dirty cover portion of film 222 can be wrapped therearound.

In some embodiments, after the contaminant 230 has been removed from the dirty cover portion of film 222, the controller 202 may reverse rotation of the first and second drive shafts 212, 214 to reposition the dirty cover portion of film 222 over the face 114 of the solar panel 100. The controller 202 may then use the one or more data sources (sensor 210, camera 240, sensors 250, etc.), as discussed elsewhere herein, to determine if a sufficient amount of contaminant 230 had been removed by the contaminant removal device 600 to extend the amount of time that the dirty cover portion of film 222 may be used.

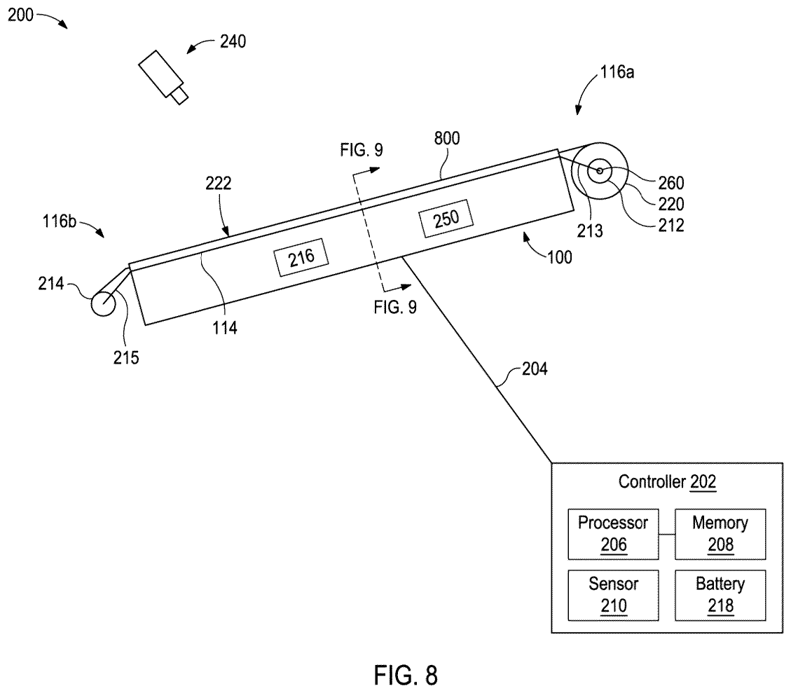

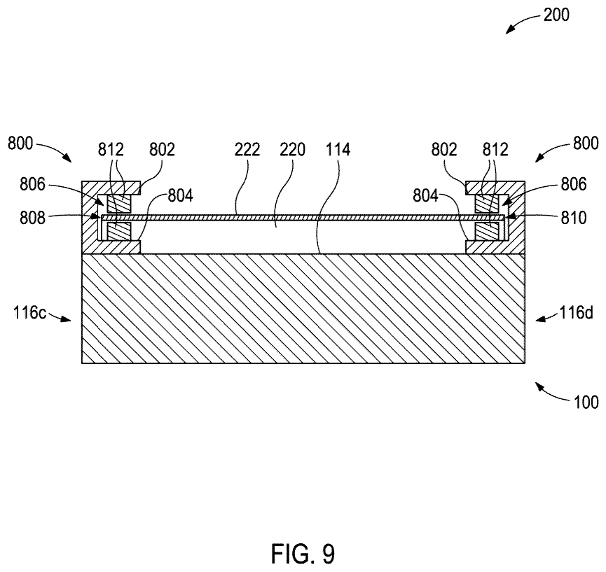

Referring now to FIGS. 8 and 9, the solar panel 100 may further include arms 800 coupled to or otherwise extending from the third and fourth sides 116c, d of the solar panel 100. The arms 800 may include a first or “upper” surface 802, a second or “lower” surface 804, and a channel 806 may be defined between the upper and lower surfaces 802, 804 and sized to receive a corresponding lateral side 808, 810 of the cover portion of film 222. In some embodiments, the arms 800 may further include a series of rollers 812 extending from the upper and lower surfaces 802, 804 along the arms 800 and which function to guide the film along the face 114 of the solar panel 100. The rollers 812 may also hold the lateral sides 808, 810 of the cover portion of film 222 to prevent contaminant 230 (FIG. 2) from getting between the cover portion of film 222 and the face 114 and prevent the cover portion of film 222 from getting caught by the wind and tearing. Alternatively, the rollers 812 may be omitted and the arms 800 may instead include low-friction pads extending from the upper and lower surfaces 802, 804. The low-friction pads may be made of Teflon or another material that has a coefficient of friction lower with the selected film material.

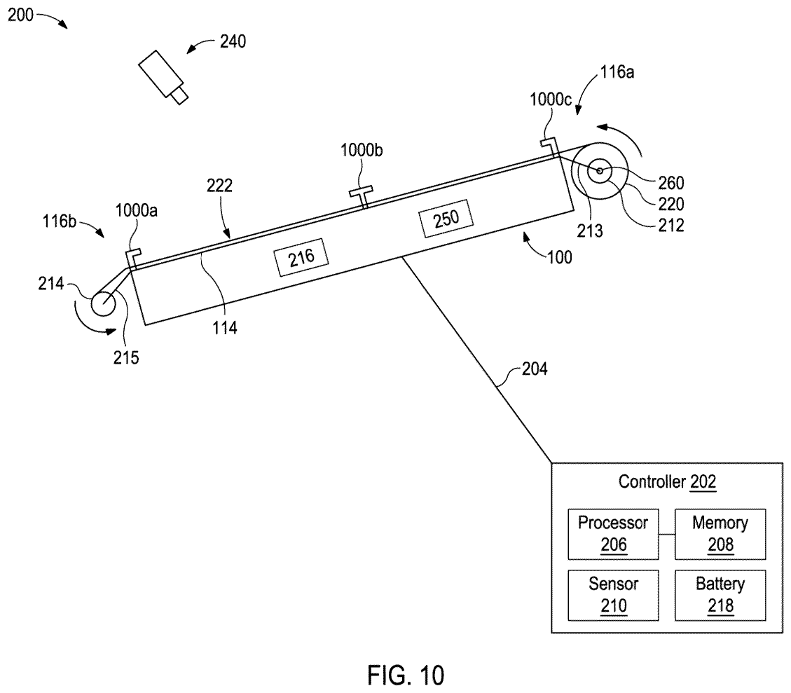

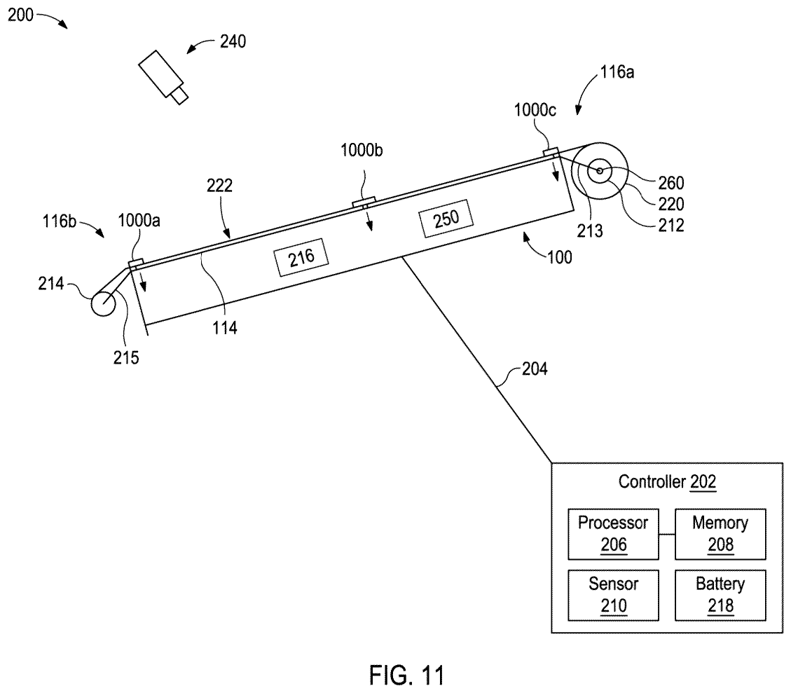

Referring now to FIGS. 10 and 11, the solar panel assembly 200 may further include a plurality of clips 1000a-c positioned along the third and fourth sides 116c, d (FIG. 1) of the solar panel 100. While only the clips 1000a-c along the fourth side 116d (FIG. 1) are visible, it should be understood that a similar arrangement of clips can be provided along the third side 116c of the solar panel 100. While three clips are shown, it should be understood that any number of clips (more or less than three) may be used and may be positioned at any desired location along the third and fourth sides 116c, d (FIG. 1), such as along the edges, like clip 1000b, or at the corners, like clips 1000a, c.

The clips 1000 may be movable relative to the solar panel 100 between a released state (FIG. 10) and a grasping state (FIG. 11). In the released state, the clips 1000a-c are displaced (disengaged) from the cover portion of film 222, whereas in the grasping state, the clips 1000a-c are engaged with the cover portion of film 222, thereby holding the cover portion of film 222 to the face 114 of the solar panel 100, and thereby ensuring that the film remains in place, even under windy conditions. The clips 1000a-c therefore ensure that the film is not offset by the wind, thereby maintaining optimal exposure of the solar panel 100 to the sun. This stability is crucial for maximizing solar energy capture, as even slight misalignments can significantly reduce the efficiency of solar panel 100.

The clips 1000a-c may be in operable communication with the controller 202 and may be transitioned between the released and grasping states by the controller 202. The controller 202 may maintain the clips 1000a-c in their grasping states (FIG. 11) while sunlight is being absorbed by the PV cells 102 (FIG. 1). Based on the controller 202 determining that the first and second drive shafts 212, 214 need rotated, as discussed elsewhere herein, the controller 202 may transition the clips 1000a-c to their released states (FIG. 10), thereby allowing the first and second drive shafts 212, 214 to wrap the cover portion of film 222 around the second drive shaft 214. Based on the controller 202 ceasing rotation of the first and second drive shafts 212, 214, as discussed elsewhere herein, the controller may transition the clips 1000a-c back to their grasping states (FIG. 11), thereby re-engaging the film (remaining dirty film or new film, for example) to hold the film against the face 114 of the solar panel 100.

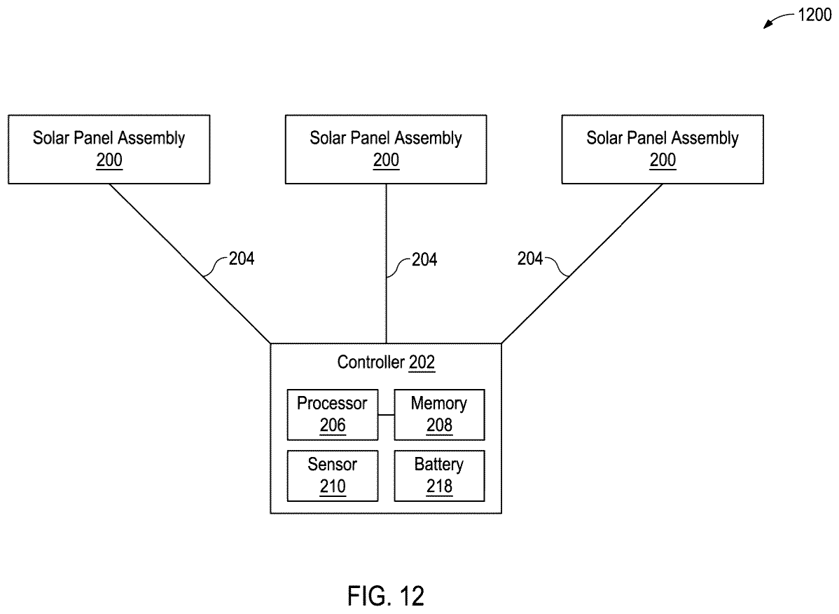

Referring now to FIG. 12, a system 1200 is provided, according to at least one aspect of the present disclosure. The system 1200 includes a plurality of solar panel assemblies 200 in operable communication with the controller 202. While three solar panel assemblies are shown, the system 1200 may include more or less than three solar panel assemblies 200. In operation, the sensor 210 may monitor the power generated by each solar panel assembly 200. The controller 202 may compute the cumulative power generated (adding each of the generated powers together) and compare the cumulative power to a cumulative power output threshold, which may be stored in the memory 208. Based on the cumulative power generated being less than the cumulative power output threshold, the controller 202 may selectively energize the motorized systems 216 (FIG. 2) of one or more of the solar panel assemblies 200 to rotate corresponding first and second drive shafts 212, 214 (FIG. 2), thereby feeding (wrapping) film from dirty cover portions of film 222 (FIG. 2) around the second drive shaft 214 (FIG. 2) while feeding (extending) new film 300 (FIG. 3) from source rolls of film 220 (FIG. 2) over the faces 114 (FIG. 1) of the solar panels 100 (FIG. 1) of the solar panel assemblies 200.

The controller 202 may select solar panel assemblies 200 to energize based on the amount of film remaining on the source rolls of film 220. For example, the controller 202 may select to energize a first solar panel assembly 200 which has a first amount of film remaining on the source roll of film 220 rather than a second solar panel assembly 200 which has a second amount of film less than the first amount of film remaining on the source roll of film 220. The controller 202 may select solar panel assemblies 200 to energize based on the amount of power generated by the solar panel assemblies 200. For example, the controller 202 may select to energize a first solar panel assembly 200 which is generating a first amount of power rather than a second solar panel assembly 200 which is generating a second amount of power more than the first amount of power. The controller 202 may select solar panel assemblies 200 to energize based on the amount of contaminant visualized on the cover portions of film 222, as visualized by the camera 240 (FIG. 2). The controller 202 may select solar panel assemblies 200 to energize based on the currents output by the plurality of sensors 250 (FIG. 2). The controller 202 may dynamically adjust which solar panel assemblies 200 to energize as sensed parameters (power output, remaining film, visualize contaminant, current output etc.) changes.

As the controller 202 selectively energizes the solar panel assemblies 200, as described above, the controller 202 may monitor the cumulative power generated by the solar panel assemblies 200 and compare the cumulative power generated to the cumulative power output threshold. Based on the cumulative generated power approaching, reaching, or exceeding the cumulative power output threshold, the controller 202 may cease providing power to the one or more motorized systems 216 (FIG. 2) of the solar panel assemblies 200. Accordingly, by selectively energizing the motorized systems 216 (FIG. 2) and comparing the cumulative generated power to the cumulative power level threshold, the controller 202 may achieve minimum energy requirements while simultaneously using up available film efficiently among a plurality of available solar panel assemblies 200.

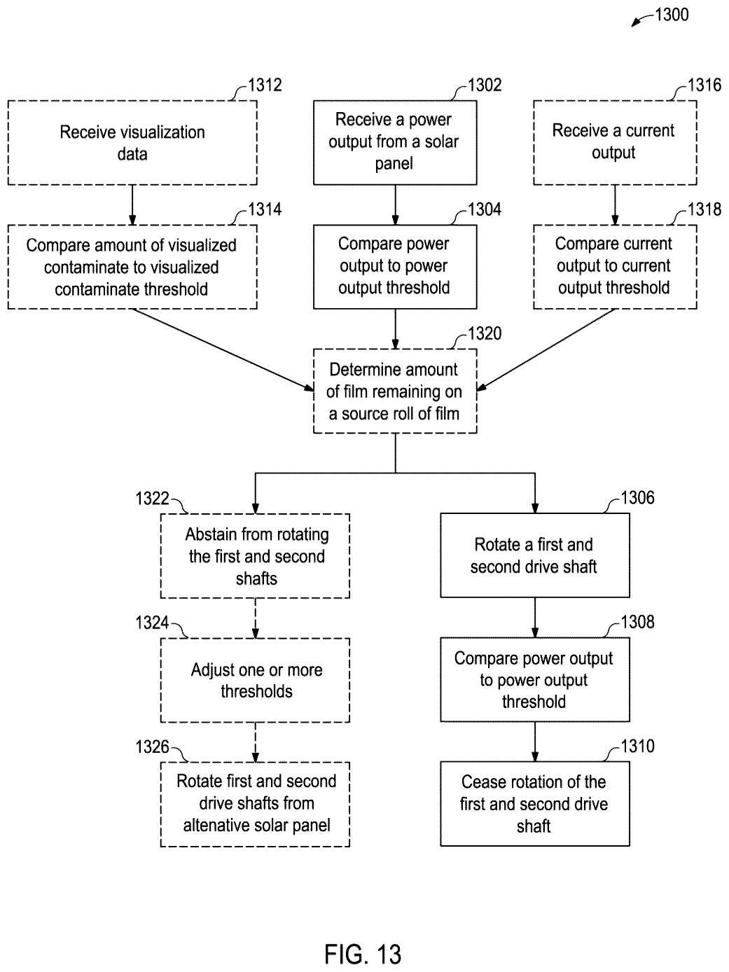

Referring now to FIG. 13, a method 1300 is provided, according to at least one aspect of the present disclosure. The method 1300 includes receiving a power output from a solar panel, as at 1302. In some aspects, a sensor, such as sensor 210 (FIG. 2), may sense an amount of power generated by a solar panel, such as solar panel 100 (FIG. 2), and a controller, such as controller 202 (FIG. 2), may receive the sensed power generated.

The method 1300 further includes comparing the power output to a power output threshold, as at 1304. In some aspects, the controller 202 (FIG. 2) compares the power generated by the solar panel 100 (FIG. 2) to a power output threshold, which may be stored in a memory, such as memory 208 (FIG. 2).

The method 1300 further includes rotating a first and second drive shaft based on the comparison, as at 1306. In some aspects, based on the power output by the solar panel 100 (FIG. 2) approaching, reaching, or dropping below the power output threshold, the controller 202 (FIG. 2) may energize a motorized system, such as motorized system 216 (FIG. 2), to rotate first and second drive shafts, such as first and second drive shafts 212, 214 (FIG. 2), thereby causing a cover portion of the film 222 (FIG. 2) to progressively wrap around the second drive shaft 214 (FIG. 2) while film from a source roll of film 220 (FIG. 2) is extended over a face 114 (FIG. 2) of the solar panel 100 (FIG. 2).

The method 1300 further includes comparing the power output to the power output threshold based on the first and second drive shafts being rotated, as at 1308. In some aspects, the controller 202 (FIG. 2) compares the power generated by the solar panel 100 (FIG. 2) to the power output threshold as the first and second drive shafts 212, 214 (FIG. 2) rotate.

The method 1300 further includes ceasing rotation of the first and second drive shafts based on the comparison, as at 1310. In some aspects, based on the power output by the solar panel 100 (FIG. 2) approaching, reaching, or exceeding the power output threshold, the controller 202 (FIG. 2) cease energizes the motorized system 216 (FIG. 2), thereby stopping rotation of the first and second drive shafts 1214, 1216 (FIG. 2).

The method 1300 optionally includes receiving visualization data, as at 1312, and comparing an amount of visualized contaminant to a contaminant threshold, as at 1314. In some aspects, a camera, such as camera 240 (FIG. 2) may visualize the cover portion of film 222 (FIG. 2) and the controller 202 (FIG. 2) may receive visualization data from the camera 240 (FIG. 2), ascertain an amount of contaminant on the cover portion of film 222 (FIG. 2), and compare the amount of visualized contaminant to a visualized contaminant threshold. Rotation of the first and second drive shafts, as at 1306, may be based on this comparison.

The method 1300 optionally includes receiving a current output, as at 1316, and comparing the current output to a current threshold, as at 1318. In some aspects, a current sensor 250 (FIG. 2) may sense a current across a subset (one or more) of PV cells 102 (FIG. 1) of the solar panel 100 (FIG. 2). The controller 202 (FIG. 2) may receive the current output from the current sensor 250 (FIG. 2), which may be indicative of an amount of light being received by the subset of PV cells 102 (FIG. 1), which may be indicative of a relative transparency of the cover portion of film 222 (FIG. 2) over the subset of PV cells 102 (FIG. 1). The controller 202 (FIG. 2) may compare the current output to a current threshold. Rotation of the first and second drive shafts, as at 1306, may be based on this comparison.

The method 1300 optionally includes determining amount of film remaining on a source roll of film, as at 1320. In some aspects, a sensor 260 (FIG. 2), such as an encoder, may be operably coupled to the first drive shaft 212 (FIG. 2) for measuring rotation of the first drive shaft 212 (FIG. 2). The controller 202 (FIG. 2) may receive rotational data from the sensor 260 (FIG. 2) and track the amount of film used from a source roll of film 220 (FIG. 2) over time. In some such aspects, based on the determined amount of film remaining on the source roll of film 220, the controller 202 may abstain from rotating the first and second drive shafts, as at 1322, adjust one or more thresholds (power output threshold, visualization contaminant threshold, current threshold, etc.), as at 1324, and/or rotate first and second drive shafts from an alternative solar panel assembly, as at 1326.

The foregoing method 1300 enables the film covering the face of the solar panel to automatically refresh over time without user intervention. The method 1300 may result in a complete refresh of film (FIG. 4). However, in some instances, the method 1300 may result in only require a partial refresh of film (FIG. 3). Accordingly, implementation of the method 1300 may result in less film being used over time, which is beneficial from an environmental perspective (less waste) and increases the amount of time between needing to replace the source roll of film.

Embodiments disclosed herein include:

A. A system including a solar panel, a drive shaft operatively coupled to the solar panel, a sensor to sense a power output from the solar panel, and a controller programmed to receive the power output from the sensor, conduct a first comparison between the power output and a power output threshold, rotate the drive shaft based on the first comparison, conduct a second comparison between the power output and the power output threshold, and cease rotation of the drive shaft based on the second comparison. Rotating the drive shaft feeds an amount of film from a source roll of film over a face of the solar panel and feeds an amount of film from a cover portion of film extending from the source roll of film around the drive shaft.

B. A method including receiving a power output from a solar panel having a drive shaft operatively coupled thereto, conducting a first comparison between the power output and a power output threshold, rotating drive shaft based on the first comparison and thereby feeding an amount of film from a source roll of film over a face of the solar panel and feeding an amount of the film from a cover portion of film extending from the source roll of film around the drive shaft, conducting a second comparison between the power output and the power output threshold, and ceasing rotation of the drive shaft based on the second comparison.

C. A system including a plurality of solar panel assemblies, a sensor to sense a power output from each solar panel assembly, and a controller. Each solar panel assembly comprises a solar panel comprising a face and including a drive shaft operatively coupled to the solar panel. Rotating the drive shaft feeds an amount of film from a source roll of film over the face of the solar panel and feeds an amount of film from a cover portion of film extending from the source roll of film around the drive shaft. The controller is programmed to receive, from the sensor, the power output, conduct a first comparison between the power output and a power output threshold, and selectively rotate the drive shafts of a subset of the plurality of solar panel assemblies based on the first comparison.

Each of embodiments A through C may have one or more of the following additional elements in any combination: Element 1: wherein the controller is further programmed to continue rotating the drive shaft when the power output is less than the power output threshold and cease rotation of the drive shaft when the power output reaches the power output threshold. Element 2: further comprising a camera to visualize the cover portion of the film, wherein the controller is further programmed to receive visualization data from the camera and rotate the drive shaft further based on the visualization data. Element 3: wherein the sensor is a first sensor and the system further comprises a second sensor to sense a parameter indicative of a transparency of the cover portion of film, and wherein the controller is further programmed to receive the parameter from the second sensor and rotate the drive shaft further based on the parameter. Element 4: wherein the controller is further programmed to determine an amount of film remaining on the source roll of film and rotate the drive shaft further based on the amount of film remaining on the source roll of film. Element 5: further comprising a cover at least partially surrounding source roll of film. Element 6: further comprising a contaminant remover operatively coupled to the solar panel and configured to remove contaminants from the cover portion of film as the cover portion of film is wrapped around the drive shaft. Element 7: wherein the solar panel further includes opposing first and second arms arranged on opposing sides of the solar panel, wherein each arm defines a channel to receive a corresponding lateral side of the film to guide the film along the face of the solar panel. Element 8: further comprising a clip moveable between a grasping state, in which the clip holds the cover portion of film to the face of the solar panel, and a released state, in which the clip is disengaged from the cover portion of film. Element 9: wherein the controller is further programmed to transition the clip to the released state prior to rotating the drive shaft and transition the clip to the grasping state based on ceasing rotation of the drive shaft.

Element 10: further comprising continuing rotating the drive shaft when the power output is less than the power output threshold and ceasing rotation of the drive shaft when the power output reaches the power output threshold. Element 11: further comprising receiving visualization data from a camera visualizing the cover portion of the film, wherein rotating the drive shaft is further based on the visualization data. Element 12: further comprising sensing a parameter indicative of a transparency of the cover portion of film, wherein rotating the drive shaft is further based on the parameter. Element 13: further comprising determining an amount of film remaining on the source roll of film, wherein rotating the drive shaft is further based on the determined amount of film remaining on the source roll of film. Element 14: further comprising removing contaminants from the cover portion of film as the cover portion of film is wrapped around the drive shaft. Element 15:further comprising receiving first and second lateral sides of the film in corresponding channels defined in arms arranged on opposing sides of the solar panel and guiding the film along the face of the solar panel with the arms. Element 16: further comprising transitioning a clip to a released state prior to rotating the drive shaft and transitioning the clip to a grasping state based on ceasing rotation of the drive shaft. Element 17: wherein the controller is further programmed to conduct a second comparison between the power output and the power output threshold and cease rotation of the drive shafts of the subset of the plurality of solar panel assemblies based on the second comparison.

By way of non-limiting example, exemplary combinations applicable to A through C include: Element 1 with Element 2; Element 1 with Element 3; Element 1 with Element 4; Element 1 with Element 5; Element 1 with Element 6; Element 1 with Element 7;Element 1 with Element 8; Element 1 with Elements 8 and 9; Element 2 with Element 3;Element 2 with Element 4; Element 2 with Element 5; Element 2 with Element 6; Element 2with Element 7; Element 2 with Element 8; Element 2 with Elements 8 and 9; Element 3 with Element 4; Element 3 with Element 5; Element 3 with Element 6; Element 3 with Element 7;Element 3 with Element 8; Element 3 with Elements 8 and 9; Element 4 with Element 5;Element 4 with Element 6; Element 4 with Element 7; Element 4 with Element 8; Element 4 with Elements 8 and 9; Element 5 with Element 6; Element 5 with Element 7; Element 5 with Element 8; Element 5 with Elements 8 and 9; Element 1 with at least two of Elements 2-9;Element 2 with at least two of Elements 1 and 3-9; Element 3 with at least two of Elements 1,2, and 4-9; Element 4 with at least two of Elements 1-3 and 5-9; Element 5 with at least two of Elements 1-4 and 6-9; Element 6 with at least two of Elements 1-5 and 7-9; Element 7 with at least two of Elements 1-6, 8, and 9; Element 8 with at least two of Elements 1-7 and 9; Element 9 with at least two of Elements 1-8; Element 10 with Element 11; Element 10 with Element 12; Element 10 with Element 13; Element 10 with Element 14; Element 10 with Element 15;Element 10 with Element 16; Element 11 with Element 12; Element 11 with Element 13;Element 11 with Element 14; Element 11 with Element 15; Element 11 with Element 16;Element 12 with Element 13; Element 12 with Element 14; Element 12 with Element 15;Element 12 with Element 16; Element 13 with Element 14; Element 13 with Element 15;Element 13 with Element 16; Element 14 with Element 15; Element 14 with Element 16;Element 15 with Element 16; Element 1 with at least two of Elements 11-16; Element 11 with at least two of Elements 10 and 12-16; Element 12 with at least two of Elements 10; 11 and 13-16; Element 13 with at least two of Elements 10-12 and 14-16; Element 14 with at least two of Elements 10-13; 15; and 16; Element 15 with at least two of Elements 10-14 and 16; and Element 16 with at least two of Elements 10-15.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe of the well.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A system, comprising:
a solar panel;
a drive shaft operatively coupled to the solar panel;
a sensor to sense a power output from the solar panel; and
a controller programmed to:
receive the power output from the sensor;
conduct a first comparison between the power output and a power output threshold;
rotate the drive shaft based on the first comparison, wherein rotating the drive shaft:
feeds an amount of film from a source roll of film over a face of the solar panel; and
feeds an amount of film from a cover portion of film extending from the source roll of film around the drive shaft;
conduct a second comparison between the power output and the power output threshold; and
cease rotation of the drive shaft based on the second comparison.

2. The system of claim 1, wherein the controller is further programmed to:
continue rotating the drive shaft when the power output is less than the power output threshold; and
cease rotation of the drive shaft when the power output reaches the power output threshold.

3. The system of claim 1, further comprising a camera to visualize the cover portion of the film, wherein the controller is further programmed to:
receive visualization data from the camera; and
rotate the drive shaft further based on the visualization data.

4. The system of claim 1, wherein the sensor is a first sensor and the system further comprises a second sensor to sense a parameter indicative of a transparency of the cover portion of film, and wherein the controller is further programmed to:
receive the parameter from the second sensor; and
rotate the drive shaft further based on the parameter.

5. The system of claim 1, wherein the controller is further programmed to:
determine an amount of film remaining on the source roll of film; and
rotate the drive shaft further based on the amount of film remaining on the source roll of film.

6. The system of claim 1, further comprising a cover at least partially surrounding source roll of film.

7. The system of claim 1, further comprising a contaminant remover operatively coupled to the solar panel and configured to remove contaminants from the cover portion of film as the cover portion of film is wrapped around the drive shaft.

8. The system of claim 1, wherein the solar panel further includes opposing first and second arms arranged on opposing sides of the solar panel, wherein each arm defines a channel to receive a corresponding lateral side of the film to guide the film along the face of the solar panel.

9. The system of claim 1, further comprising a clip moveable between a grasping state, in which the clip holds the cover portion of film to the face of the solar panel, and a released state, in which the clip is disengaged from the cover portion of film.

10. The system of claim 9, wherein the controller is further programmed to:
transition the clip to the released state prior to rotating the drive shaft; and
transition the clip to the grasping state based on ceasing rotation of the drive shaft.

11. A method, comprising:
receiving a power output from a solar panel having a drive shaft operatively coupled thereto;
conducting a first comparison between the power output and a power output threshold;
rotating drive shaft based on the first comparison and thereby:
feeding an amount of film from a source roll of film over a face of the solar panel; and
feeding an amount of the film from a cover portion of film extending from the source roll of film around the drive shaft;
conducting a second comparison between the power output and the power output threshold; and
ceasing rotation of the drive shaft based on the second comparison.

12. The method of claim 11, further comprising:
continuing rotating the drive shaft when the power output is less than the power output threshold; and
ceasing rotation of the drive shaft when the power output reaches the power output threshold.

13. The method of claim 11, further comprising receiving visualization data from a camera visualizing the cover portion of the film, wherein rotating the drive shaft is further based on the visualization data.

14. The method of claim 11, further comprising sensing a parameter indicative of a transparency of the cover portion of film, wherein rotating the drive shaft is further based on the parameter.

15. The method of claim 11, further comprising determining an amount of film remaining on the source roll of film, wherein rotating the drive shaft is further based on the determined amount of film remaining on the source roll of film.

16. The method of claim 11, further comprising removing contaminants from the cover portion of film as the cover portion of film is wrapped around the drive shaft.

17. The method of claim 11, further comprising:
receiving first and second lateral sides of the film in corresponding channels defined in arms arranged on opposing sides of the solar panel; and
guiding the film along the face of the solar panel with the arms.

18. The method of claim 11, further comprising:
transitioning a clip to a released state prior to rotating the drive shaft; and
transitioning the clip to a grasping state based on ceasing rotation of the drive shaft.

19. A system, comprising:
a plurality of solar panel assemblies, each solar panel assembly comprising a solar panel comprising a face and including a drive shaft operatively coupled to the solar panel, wherein rotating the drive shaft:
feeds an amount of film from a source roll of film over the face of the solar panel; and
feeds an amount of film from a cover portion of film extending from the source roll of film around the drive shaft;
a sensor to sense a power output from each solar panel assembly; and
a controller programmed to:
receive, from the sensor, the power output;
conduct a first comparison between the power output and a power output threshold; and
selectively rotate the drive shafts of a subset of the plurality of solar panel assemblies based on the first comparison.

20. The system of claim 19, wherein the controller is further programmed to:
conduct a second comparison between the power output and the power output threshold; and
cease rotation of the drive shafts of the subset of the plurality of solar panel assemblies based on the second comparison.
